(19) United States
(12) Patent Application Publication
(10) Pub. No.: US 2006/0221294 A1
(43) Pub. Date: Oct. 5, 2006

(54) Liquid crystal display device and method for manufacturing the same

(75) Inventors: Yun Szu Liu, Miao-Li (TW); Tsau Hua Hsieh, Miao-Li (TW); Kun Hsing Hsiao, Miao-Li (TW)

Correspondence Address: WEI TE CHUNG;FOXCONN INTERNATIONAL, INC., 1650 MEMOREX DRIVE, SANTA CLARA, CA, 95050, US

(73) Assignee: INNOLUX DISPLAY CORP.

(21) Appl. No.: 11/397,530

(22) Filed: Apr. 3, 2006

(30) Foreign Application Priority Data
Apr. 1, 2005 (TW) 94110567

(51) Int. Cl. G02F 1/1339

(52) U.S. Cl. 349/155

(57) ABSTRACT

A liquid crystal display device (LCD) and a method for manufacturing the same are shown. The LCD includes a first substrate (41), a second substrate (42) opposite to the first substrate and a liquid crystal layer (43) between the first substrate, and the second substrate. A number of photospacers (44) are arranged on the first substrate and a conductive layer covers (440) on the photospacers. A number of common lines (421) are arranged on the second substrate and the conductive layer covered on the photospacers interconnects with the common lines electrically.

### FIELD OF THE INVENTION

The present invention relates to liquid crystal display devices (LCDs) and methods for manufacturing LCDs.

### GENERAL BACKGROUND

Reference is made to FIG. 2, which is a cross-sectional view of part of a typical liquid crystal display device of the prior art. The liquid crystal display device 1 includes a first substrate 11, a second substrate 12 positioned opposite to the first substrate 11, a color filter 15 positioned at the first substrate 11, a liquid crystal layer 13 positioned between the first substrate 11 and the second substrate 12, and a plurality of spacers 14. Each of the spacers 14 is usually transparent and generally spherical. The spacers 14 are used to support the first substrate 11, so that the spacing between the first substrate 11 and the second substrate 12 for the liquid crystal layer 13 is uniform. Because the spacers 14 are usually distributed on the second substrate 12 by a dedicated distributor, the liquid crystal display device 1 generally has a low contrast ratio.

To overcome the above-mentioned problem, a liquid crystal display device such as that shown in FIG. 3 has been developed. The liquid crystal display device 2 includes a first substrate 21, a second substrate 22 positioned opposite to the first substrate 21, and a liquid crystal layer 23 positioned between the first substrate 21 and the second substrate 22.

In addition, a color filter 25 and a black matrix 26 are positioned on an underside of the first substrate 21; and a protective layer 241 and an Indium Tin Oxide (ITO) layer 240 are sequentially positioned on an underside of the color filter 25 and the black matrix 26. Further, a plurality of photospacers 24 are positioned on an underside of the ITO layer 240. The photospacers 24 are used to support the first substrate 21, so that the spacing between the first substrate 21 and the second substrate 22 for receiving the liquid crystal layer 23 is uniform. Usually, the photospacers 24 are made of transparent material. With the photospacers 24 employed in the liquid crystal display device 2, the liquid crystal display device 2 has the capability to withstand external force such as shock or vibration, and the contrast ratio and prevention of light leakage of the liquid crystal display device 2 are improved.

The photospacers 24 are positioned on the ITO layer 240, and are used to support the first substrate 21 after the first substrate 21 is assembled with the second substrate 22. Thereupon, the liquid crystal layer 23 is formed between the first substrate 21 and the second substrate 22. When the size of the liquid crystal display device 2 is relatively large, the number of color pixels and common electrodes may be significantly increased. Thus, the time needed to transmit signals from one common line adjacent to driver Integrated circuit (IC) to another common line far away the driver IC may be unduly long. This can result in time delays occurring in the displaying of images by the liquid crystal display device 2. In addition, for electrically connecting the ITO layer 240 with the common lines, a conductive adhesive distribution process is needed to connect the ITO layer with the common lines. But the conductive adhesive distribution process induce an uneven spacing between the first substrate 21 and the second substrate 22.

What is needed, therefore, is a liquid crystal display device and a method for manufacturing the same which can overcome the above-described problems.

### SUMMARY

In a preferred embodiment, a liquid crystal display device includes a first substrate, a second substrate positioned opposite to the first substrate and a liquid crystal layer positioned between the first substrate and the second substrate. A plurality of photospacers are positioned on the first substrate, and each photospacer is covered by a conductive layer. A plurality of common lines are implemented at the second substrate and are electrically connected with the conductive layers of the photospacers.

In another preferred embodiment, a method for manufacturing a liquid crystal display device includes the steps of: providing a first substrate and a second substrate; positioning a color filter and a black matrix on one side of the first substrate corresponding to the second substrate and the color filter and the black matrix interlaced; forming a first protective layer on the color filter and the black matrix; forming a plurality of photospacers on the first protective layer and then forming a first transparent conductive layer on the first protective layer; forming a common line on the second substrate; sequentially forming an isolation layer and a second protective layer on the common line; forming a contact hole corresponding to the photospacer and on the isolation layers and the second protective layer, and a second transparent conductive layer arranged on the contact hole; positioning an alignment film on the second substrate including the above-mentioned structure; after assembling the first substrate with the second substrate so that the photospacers are in contact with the second transparent conductive layer of the second substrate; and filling liquid crystal into a spacing between the first substrate and the second substrate so that a liquid crystal layer is formed.

The alignment film may be penetrated by the photospacers after the first substrate is assembled with the second substrate. Thus, the conductive layer positioned on outer surfaces of the photospacers is in electrical contact with the common lines on the second substrate. Signals are transmitted to the common lines from one or more driver ICs without undue delay, so that the uniformity of an image of the liquid crystal display device is significantly improved.

In addition, the photospacers can be positioned according to any desired pattern, with the first transparent conductive layer being provided on exposed surfaces thereof. Thus, any conventional conductive adhesive distribution process can be omitted, and the spacing between the first substrate and the second substrate can be uniform. As a result, line yield for mass manufacturing the liquid crystal display device is improved.

Other advantages and novel features will become more apparent from the following detailed description when taken in conjunction with the accompanying drawings.

### BRIEF DESCRIPTION OF THE DRAWINGS

FIG. 1 is a cross-sectional view of part of a liquid crystal display device according to an exemplary embodiment of the present invention.

FIG. 2 is a cross-sectional view of part of a typical liquid crystal display device of the prior art.

FIG. 3 is a cross-sectional view of part of another kind of liquid crystal display device of the prior art.

### DETAILED DESCRIPTION

The following detailed description is of the best presently contemplated modes of carrying out the invention. This description is not to be taken in a limiting sense, but is made merely for the purpose of illustrating general principles of embodiments of the invention. The scope of the invention is best defined by the appended claims and equivalents thereof.

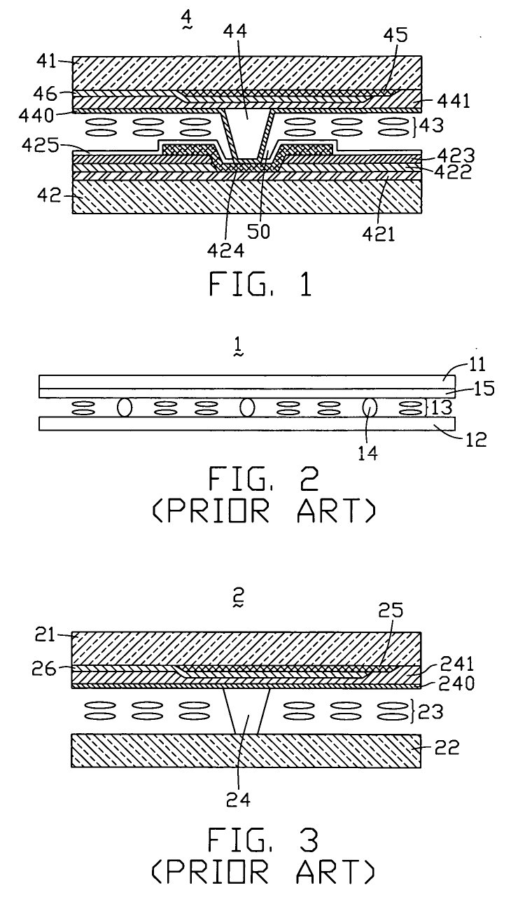

Reference is made to FIG. 1, which is a cross-sectional view of part of a liquid crystal display device according to an exemplary embodiment of the present invention. For clarity, only one pixel area of the liquid crystal display device is shown. The liquid crystal display device 4 includes a first substrate 41, a color filter 46 and a black matrix 45 positioned substantially on an underside of the first substrate 41, a second substrate 42 positioned opposite to the first substrate 41, and a liquid crystal layer 43 sandwiched between the first substrate 41 and the second substrate 42.

A first protective layer 441 is arranged substantially on an underside of the color filter 46 and the black matrix 45, and a plurality of photospacers 44 (only one shown) are distributed on an underside of the first protective layer 441. That is, the first protective layer 441 is disposed between the color filter 46 and the photospacers 44. Each of the photospacers 44 is a substantially frustum-shaped block. A first transparent conductive layer 440 is formed on exposed surfaces of the photospacers 44 and on an underside of portions of the first protective layer 441 between the photospacers 44. Typically, the first transparent conductive layer 440 is made of Indium Tin Oxide (ITO) or Indium Zinc Oxide (IZO).

A plurality of common lines 421, an isolation layer 422, a second protective layer 423, a second transparent conductive layer 424 and an alignment film 425 are substantially sequentially positioned on a top side of the second substrate 42. A plurality of contact holes 50 are defined in the isolation layer 422 and the second protective layer 423. Each contact hole 50 is commonly defined in the isolation layer 422 and the second protective layer 423, and corresponds to a respective one of the photospacers 44. A respective part of the second transparent conductive layer 424 is used to fill each contact hole 50, and another respective part of the second transparent conductive layer 424 overlaps the second protective layer 423 around each contact hole 50. In this regard, a respective portion of the second transparent conductive layer 424 is electrically connected with a corresponding common line 421 through each contact hole 50. The second transparent conductive layer 424 is typically made of Indium Tin Oxide (ITO) or Indium Zinc Oxide (IZO).

In assembly, initially, the alignment film 425 covers exposed portions of the second transparent conductive layer 424 and the second protective layer 423. Then when the first substrate 41 is attached to the second substrate 42, the photospacers 44 essentially penetrate through the alignment film 425 at the contact holes 50. Thus, the first transparent conductive layer 440 positioned on the exposed surfaces of the photospacers 44 is electrically connected with the second transparent conductive layer 424 on the second substrate 42 in the contact holes 50, so that the first transparent conductive layer 440 is electrically connected with the common lines 421. Signals are transmitted from one or more driver ICs of the liquid crystal display device 4 to the common lines 421 via the first and second transparent conductive layers 440, 424 without delay. Therefore the uniformity of a corresponding image of the liquid crystal display device 4 can be significantly improved.

In addition, the photospacers 44 can be positioned according to any desired pattern, with the first transparent conductive layer 440 being provided on the exposed surfaces thereof. Thus, any conventional conductive adhesive distribution process can be omitted, and the spacing between the first substrate 41 and the second substrate 42 can be uniform. As a result, line yield for mass manufacturing the liquid crystal display device 4 is improved.

A method for manufacturing a liquid crystal display device 4 according to another exemplary embodiment of the present invention includes the steps of providing a first substrate 41 and a second substrate 42; forming a black matrix 45 and a color filter 46 substantially on an underside of the first substrate 41; forming a first protective layer 441 substantially on an underside of the color filter 46 and the black matrix 45, the first protective layer 441 being made of silicon dioxide (SiO₂) or silicon nitride (Si₃N₄); forming a plurality of photospacers 44 on the first protective layer 441; forming a first transparent conductive layer 440 on the photospacers 44 and exposed portions of the first protective layer 441; forming a common line 421 on the second substrate 42; sequentially forming an isolation layer 422 and a second protective layer 423 on the common line 421; forming a plurality of contact holes 50 corresponding to the photospacers 44 in the isolation layers 422 and the second protective layer 423; positioning a second transparent conductive layer 424 in the contact holes 50; and positioning an alignment film 425 on exposed portions of the second substrate 42 having the above-mentioned structure.

Next, the first substrate 41 is attached to the second substrate 42. In this process, the photospacers 44 substantially penetrate the alignment film 425, so that the first transparent conductive layer 440 at the photospacers 44 is in mechanical and electrical contact with the transparent conductive layer 424 in the contact holes 50. Thus, the first transparent conductive layer 440 at the photospacers 44 is electrically connected with the common lines 421 through the second transparent conductive layer 424. Liquid crystal is then filled into the space between the first substrate 41 and the second substrate 42, so that a liquid crystal layer 43 is formed.

While the invention has been described by way of example and in term of preferred embodiments, it is to be understood that the invention is not limited thereto. To the contrary, the description is intended to cover various modifications and similar arrangements, as would be apparent to those skilled in the art. Therefore, the scope of the appended claims should be accorded the broadest interpretation so as to encompass all such modifications and similar arrangements.

We claim:

1. A liquid crystal display device, comprising:
a first substrate;
a second substrate opposite to the first substrate; and
a liquid crystal layer sandwiched between the first substrate and the second substrate;
wherein a plurality of photospacers are positioned at an inside of the first substrate, each photospacer is partially covered by a first transparent conductive layer, a plurality of common lines are provided at the second substrate, and the photospacers extend toward the second substrate whereby the first transparent conductive layers are electrically connected with the common lines.

2. The liquid crystal display device as claimed in claim 1, wherein each photospacer is substantially frustum-shaped.

3. The liquid crystal display device as claimed in claim 1, wherein an isolation layer is positioned on the common lines, and a plurality of contact holes corresponding to the photospacers are defined in the isolation layer.

4. The liquid crystal display device as claimed in claim 3, wherein the isolation layer is made of silicon dioxide (SiO₂) or silicon nitride (Si₃N₄).

5. The liquid crystal display device as claimed in claim 4, wherein a second transparent conductive layer is arranged over the isolation layer and in the contact holes, whereby the first transparent conductive layers are electrically connected with the common lines via the second transparent conductive layer.

6. The liquid crystal display device as claimed in claim 5, wherein the second transparent conductive layer is made of Indium Tin Oxide (ITO) or Indium Zinc Oxide (IZO).

7. The liquid crystal display device as claimed in claim 1, wherein the photospacers are made of transparent material.

8. The liquid crystal display device as claimed in claim 1, wherein the first transparent conductive layer is made of Indium Tin Oxide (ITO) or Indium Zinc Oxide (IZO).

9. The liquid crystal display device as claimed in claim 1, further comprising a protective layer arranged between the first substrate and the photospacers.

10. The liquid crystal display device as claimed in claim 9, further comprising a color filter and a black matrix positioned between the first substrate and the protective layer.

11. A method for manufacturing a liquid crystal display device, including the steps of:
providing a first substrate and a second substrate;
positioning a color filter and a black matrix at an inside of the first substrate;
forming a first protective layer on the color filter and the black matrix;
forming a plurality of photospacers on the first protective layer;
forming a first transparent conductive layer on exposed portions of the photospacers;
forming a plurality of common lines at the second substrate;
forming an isolation layer on the common lines, the isolation layer having a plurality of contact holes corresponding to the photospacers;
positioning an alignment film on the second substrate including the above-mentioned structure;
attaching the first substrate to the second substrate such that the photospacers substantially penetrate the alignment film whereby the first transparent conductive layers of the photospacers are in electrical contact with the common lines; and
filling liquid crystal into a space between the first substrate and the second substrate whereby a liquid crystal layer is formed.

12. A liquid crystal display device, comprising:
a first substrate;
a second substrate spaced from and opposite to the first substrate;
a first conductive layer applied upon the first substrate facing toward the second substrate;
a second conductive layer applied upon the second substrate facing toward the first substrate;
a liquid crystal layer sandwiched between the first substrate and the second substrate; and
a plurality of photospacers are positioned between the first substrate and the second substrate; wherein
at least one of said first and second conducive layer extend toward and reach the other so as to form a closed receiving sapce receiving said photospacers therein and isolating said photospacers from the liquid crystal layer.

13. The liquid crystal display device as claimed in claim 12, wherein said closed receiving space is formed by said one of the first and second conductive layers and the corresponding substrate applied thereunto.

14. The liquid crystal display device as claimed in claim 13, wherein said closed receiving space defines a tapered configuration toward the other of said first and second conductive layers.

15. The liquid crystal display device as claimed in claim 12, wherein the other of said first and second conductive layers forms a recess to receive a protrusion of said one of the first and second conductive layers.
